(19) United States
(12) Patent Application Publication
(10) Pub. No.: US 2006/0131106 A1
(43) Pub. Date: Jun. 22, 2006

(54) Accessory container holder mountable on a ladder

(76) Inventor: David L. Adams, Pickerington, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/300,550

(22) Filed: Dec. 14, 2005

Related U.S. Application Data
(60) Provisional application No. 60/636,644, filed on Dec. 16, 2004.

(51) Int. Cl. E06C 5/32

(52) U.S. Cl. 182/129

(57) ABSTRACT

A ladder accessory device useful in combination with a ladder to supportably hold one or two container holders in a convenient and easy to reach position for a person working on the ladder. A pair of container holders are removably mounted in laterally spaced, longitudinally aligned position along the length of the ladder. The container holders may include arms which pass through laterally spaced holes provided in aligned relationship to one another along the length of the legs of the ladder. Means are included to releasably fix the arm and the container holders in selected positions along the length of said legs.

### CROSS-REFERENCES TO RELATED APPLICATIONS

This application claims the benefit of U.S. Provisional Application No. 60/636,644 filed Dec. 16, 2004.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to accessory items useful for performing maintenance work in and around residential homes requiring the use of a ladder.

2. Description of the Related Art

Maintenance in and about residences often require the use of a ladder of the extension type or the common stepladder. In many instances, particularly painting the inside or outside of homes, the use of a ladder is required. However, while many forms for providing means to hold a paint container have been used in the past, each has shown to have limitations which either are inconvenient in some circumstances or fail to possess characteristics or features which would solve other problems associated with such work.

Prior to the present invention, those of ordinary skill in the art have not satisfactorily produced a ladder accessory item which satisfactorily addresses such maintenance work to provide more convenience and efficiency to the user.

### BRIEF SUMMARY OF THE INVENTION

The present invention is directed to accessory apparatus particularly useful with many conventional ladders of the type commonly used for painting and other maintenance work around buildings and particularly around residences.

It is one aspect of a preferred embodiment of the present invention to provide a container holder device which easily and simply may be removably mounted to a ladder wherein containers for paint or tools may be mounted in an easily reached and convenient position.

It is another aspect of the present invention to provide a pair of container holders adapted to be removably mounted in aligned relationship along the outside of and along the longitudinal extent of the legs of a ladder in a position convenient to the user.

It is another aspect of the present invention in a preferred embodiment to provide a pair of open basket-like container holders, each having an outwardly extending arm extendable through openings in the legs of the ladder toward one another to join in a removably fixed telescoping relationship.

It is another aspect of the present invention to provide a mounting means adopted to be removably mounted on a step of a conventional step ladder to removably receive the container holders particularly useful for conventional step ladders without providing openings along the legs of the step ladder.

It is therefore an object of the present invention to provide an accessory for use with ladders wherein paint and/or tool containers may be adjustably mounted to a ladder in an easy manner to facilitate maintenance work in an improved manner.

It is another object of the present invention to provide an apparatus of the type described for use in cooperation with a ladder which is simple and inexpensive to manufacture and therefore highly affordable to the potential users.

### BRIEF DESCRIPTION OF THE SEVERAL VIEWS OF THE DRAWINGS

FIG. 1 is a perspective view of an embodiment of the ladder accessory device constructed in accordance with the present invention;

FIG. 2 is a perspective view drawing each one of a pair of container holders shown in FIG. 1, the view illustrating each one of the pair in a separated relationship prior to being mounted to a ladder;

FIG. 3 is a top plan view of the embodiment shown in FIG. 1;

FIG. 4 is a side elevational view of the embodiment shown in FIG. 1;

FIG. 5 is an end elevational embodiment shown in FIG. 1;

FIG. 6 is an exploded view of the embodiment shown in FIG. 1 in combination with one form of ladder;

FIG. 7 is a perspective view of an embodiment of the present invention showing the embodiment in an operational combination with one form of ladder.

FIGS. 8 and 9 are perspective views of a mounting means suitable for use on a conventional step ladder to provide another embodiment of the present invention;

FIG. 10 is a perspective view of the mounting means shown in FIGS. 8 and 9 in combination with the container holders as may be typically mounted on a conventional step ladder; and

FIG. 11 is a partial side sectional view of the combination of the mounting means and container holders illustrating their relationship in the mounted condition shown in FIG. 10.

In describing the preferred embodiments of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used.

### DETAILED DESCRIPTION OF THE INVENTION

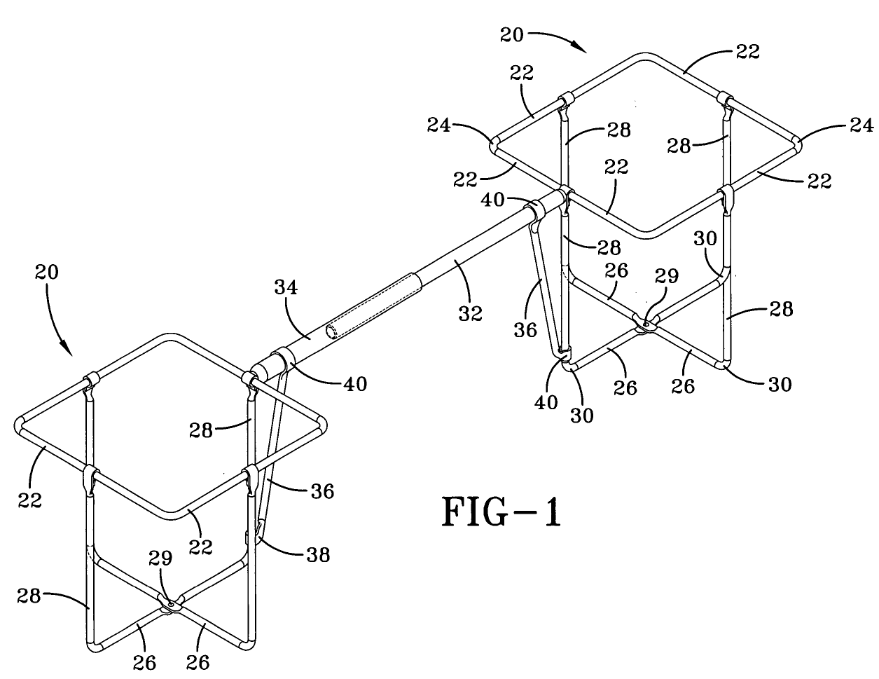

A ladder accessory device constructed in accordance with the present invention is shown in the form of one preferred embodiment in FIG. 1 and includes a pair of similar container holders indicated generally at 20. Container holders 20 comprise an open type construction which herein means a form having side and bottom supports which do not form continuous enclosed sidewalls or a closed bottom wall. However, while preferred, continuously closed sidewalls and/or bottom wall may be employed without departing from the spirit of the present invention.

Each container holder 20, as shown in FIG. 1, includes a top opening surrounded by an upper rim formed by a hollow rod-like or tubular elements 22. The ends of each element 22 may be joined to an adjacent element 22 by an elbow like joint such as at 24 which may be fixed in any conventional manner to the adjacent end of an adjoining element as 22 to form the closed upper rim as shown in the preferred embodiment. The joint formed at 24 may be fixed by soldering or welding, for example. The elbow joint may be a separate body or one or both ends of adjoining elements 22 may be bent to form the arcuate joint.

A bottom wall support is formed by two hollow rod-like elements 26, generally similar to elements 22, which are extended across one another at approximately a right angle and may be joined in their center to one another in any conventionally suitable manner. In FIG. 1, bottom elements 26 are shown flattened in the center and fixed with a rivet 29. However, other means such as soldering, welding or use of a suitable adhesive, for example, may be used as deemed suitable.

The outwardly extending ends of elements 26 may be fixed at 30 to the lower ends of four side support elements 28. Elements 28 preferably are similar to the hollow rod elements 22 and 26. The lower ends of side support elements 28 and the outward ends of elements 26 may be joined by an elbow shaped configuration such as employed at 24, or in any other conventional well-known suitable manner to form an enclosure capable of holding a container which generally fits within the top opening of a holder 20.

The upper ends of each side element 28 may be fixed in any suitable conventional manner to a respective one of elements 22. One preferred form may comprise flattening an upper end portion of each element 28 and bending it into a generally U-shape which fits around the element 22 and fixing the joinder by soldering, welding or by other suitable fastening means.

It should be pointed out that while an open or frame-like construction is preferred to reduce manufacturing costs and the weight of the holder 20, other forms having equivalent functionality may be employed without departing from the spirit of the present invention, including a holder having closed side and bottom walls and a top opening. Further, elements such as 24, 26 and 29 may comprise metal or plastic tubing of sufficient strength to support the intended containers disposed in the holders 20.

Each container holder 20 is provided with an outwardly extending arm, such as 32 and 34. The inner ends of such arm 32 and 34 may be joined to one of rim elements 22 by butt welding, for example, and supported by diagonal members 36, one of which is fixed to a respective arm 32 or 34 as seen in the Figures.

A similar flattening of the end portions of hollow rod-like elements 36 and bending to a generally U-shaped configuration may be usefully employed such as shown at 38 and 40. The joinder at 38 and 40 may be similarly fixed by soldering, welding or other suitable conventional means.

Arms 32 and 34 preferably have a hollow tube configuration wherein the diameters permit one arm to be telescoped within the other arm for purposes as described below herein.

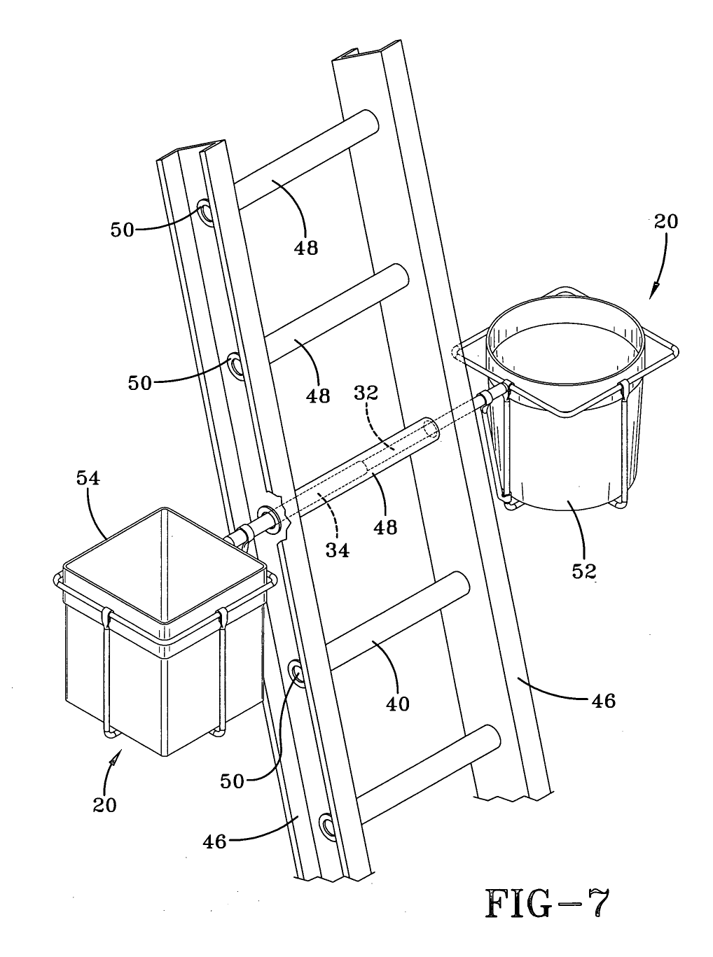

Now specifically referring to FIG. 6 and a portion of a conventional aluminum extension ladder, indicated generally at 44, which comprises laterally spaced legs 46 and longitudinally spaced, fixed, rungs or steps 48. In the ladder of well-known conventional construction, the rungs 48 are tubular, having an open passage extending to an open end 50 at opposing ends of each rung 48.

Container holders 20 may be removably mounted to ladder 44 by inserting a respective one of arms 32 and 34 into the opposing open ends 50 of a rung 48 at a selected position along the length of ladder 44 usually dependent upon a user's position on ladder 44 relative to the work intended to be performed.

Either before or after mounting holders 20 as shown, a container, such as 52 and 54, may be disposed within each one of open basket type holders 20 to securely support the containers 52 and 54 in a convenient and easy to reach position for the user.

For illustration purposes, container 52 represents a paint can or the like. Container 54 represents a suitable closed wall container, a plastic bucket for example, of a suitable size to fit within a container holder 20. Container 54 may be used to store extra tools helpful for the particular maintenance work being performed, such as scrapers, brushes, wiping cloths, putty knives or the like, useful when doing a painting or other task. However, other tools may also be so stored in a ready-to-use position in container 54 as described and two containers such as 54 may be employed for maintenance work other than painting that require the use of a ladder, such as 44.

As shown and described herein, it should be readily understood that the apparatus of the present invention represents a markedly convenient improvement aid to many maintenance chores, yet is simple and inexpensive to manufacture and significantly facilitates the work being done in a more efficient manner.

When the user needs to move up or down ladder 44, each container holder 20 may be readily moved to a different rung 48 as needed. One merely needs to release the means for fixing arms 32 and 34 from within a given rung 48 and move each holder 20 accordingly to a different rung 48.

In the preferred embodiment shown, a simple pin and hole arrangement in arms 32 and 34 may be employed to releasably fix arms 32 and 34 in their telescoped relationship. However, other suitable conventional methods and means well-known to those of ordinary skill may also be employed without departing from the spirit of the present invention to provide an equivalent function.

It should also be pointed out that the container holders 20 may also be employed with a conventional stepladder. However, with an extension ladder or a stepladder wherein the rungs or steps are solid or have no end open hollow construction, one merely has to provide suitable holes laterally aligned along the length of parallel extending legs of the ladder to provide openings capable of receiving arms 32 and 34 in essentially the same manner as described herein. Such holes may be drilled using readily available tools. In this configuration, the present invention is utilized in an equivalent manner to provide equivalent results of convenience and expediting a given maintenance chore.

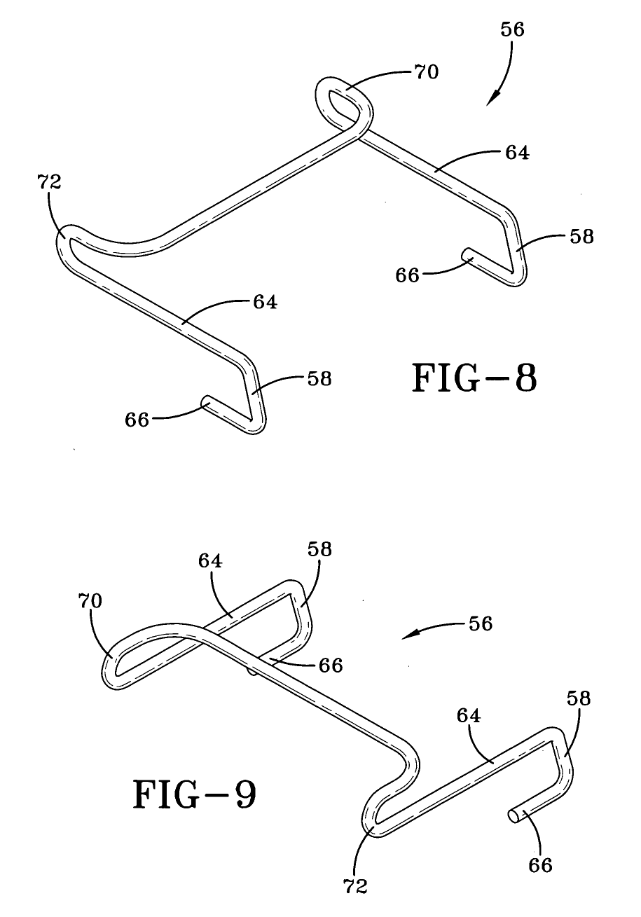

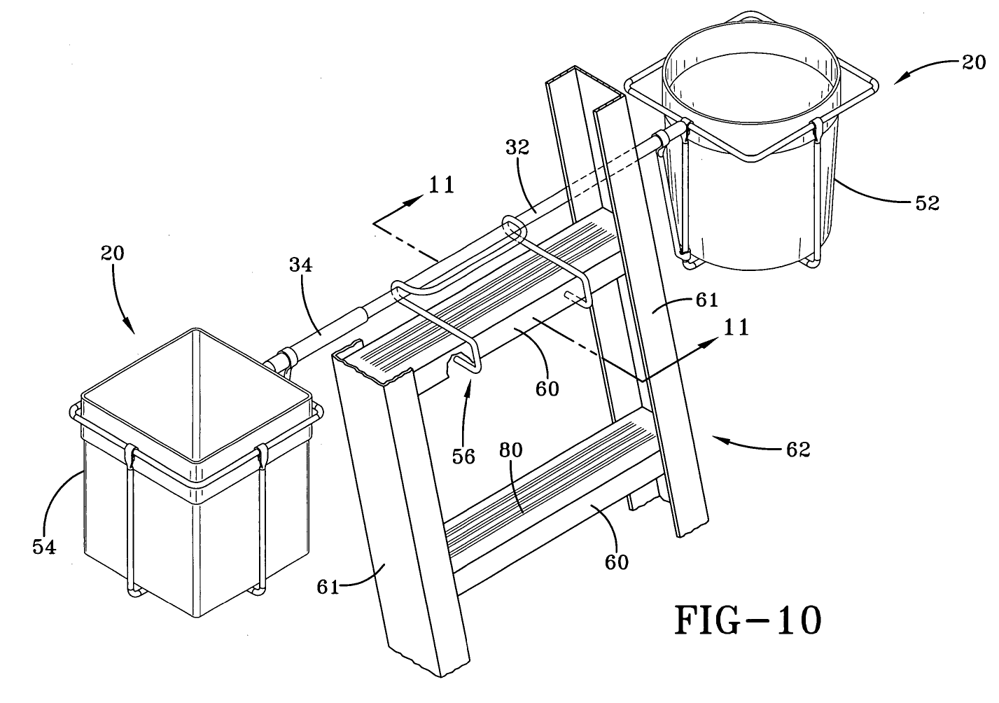

Another embodiment of the present invention is shown in FIGS. 8-11 which is particularly useful for most conventional step ladders and does not require drilling openings in the legs of the step ladder to mount the container holders 20.

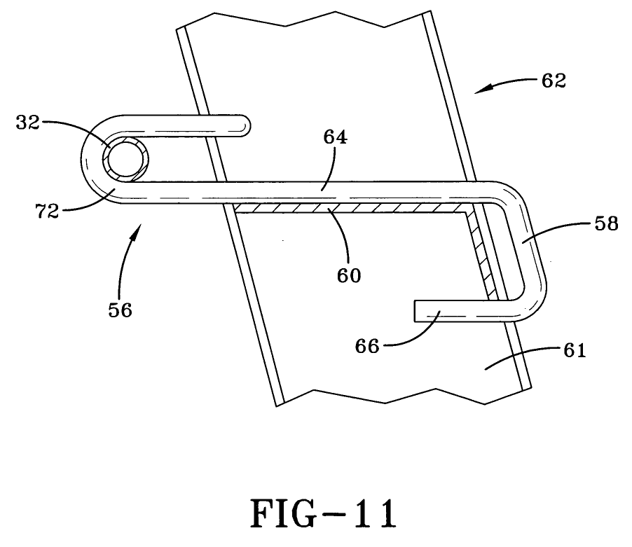

A mounting means indicated generally at 56 preferably comprises a one piece construction of a metal or plastic material, for example, having a pair of openings, such as generally C-shaped ends 58, spaced from one another and adapted to be received under and over a step portion 60 of a conventional step ladder, generally indicated at 62 in FIG. 10. The longer leg 64 of the C-shaped ends 58 fits over the top of the step 60 and the shorter leg 66 slides under the step 60 to support the spaced loops or openings 70 and 72 formed at the opposite ends of mounting means 56 as best seen in FIGS. 10 and 11. Mounting means 56 may be constructed from a single heavy gauge metal wire and bent into the shape shown or of any other suitable material molded, bent or otherwise constructed to a suitable functionally equivalent shape, or a combination of materials capable of constructing a similar functional shape using well-known manufacturing methods. The C-shaped shown wherein the C-shaped ends are formed at generally a right angle, may be formed with a more U-shape if deemed desirable and functionally suitable.

With specific reference to FIGS. 10 and 11, a partial view of a conventional step ladder indicated generally at 62 with the container holders 20 and mounting means 56 operatively mounted on the ladder 62 with containers 52 and 54 positioned within holders 20 illustrate a typical functional position for use of the present invention.

Step ladder 62 typically includes spaced, parallel legs 61 and a plurality of steps 60 longitudinally spaced along the length of legs 61.

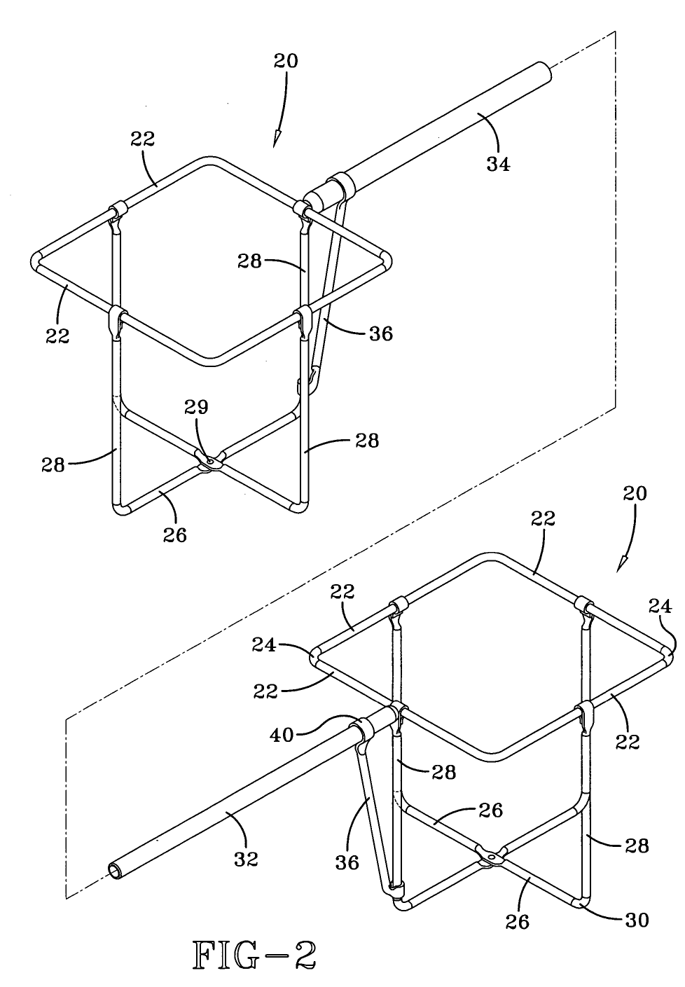

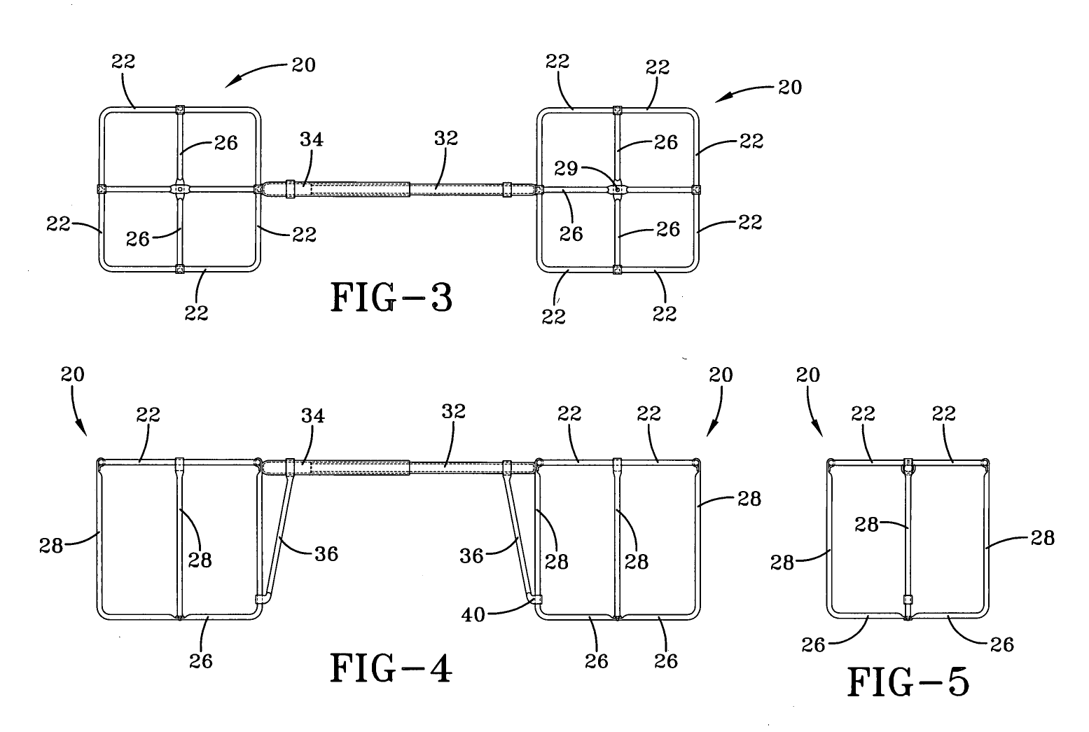

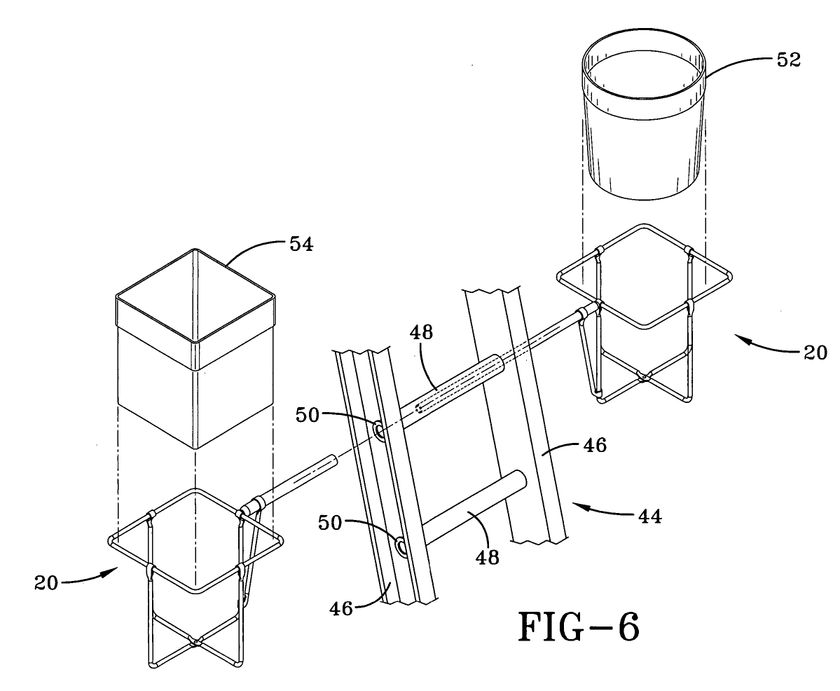

To use the embodiment shown in FIGS. 8-11, one merely mounts mounting means 56 to a step 60 by placing the C-shaped ends 58 under and over step 60 as shown in FIGS. 10 and 11 with the longer legs 64 resting on and engaging the upper surface 80 and the shorter legs 66 engaging an underside of step 60. The opposing end of mounting means 56 with openings 70 and 72 are then removably fixed beyond the rear end of step 60. Then the outwardly extending arms 32 and 34 may be extended through the openings 70 and 72 in a similarly functional manner as described earlier herein with respect to the embodiment shown in FIGS. 1-7 to mount container holders 20 in a stable position outside the width between legs 61 of step ladder 62. Then suitable containers such as 52 and 54 may be removably mounted within container holders 20.

While certain preferred embodiments of the present invention have been disclosed in detail, it is to be understood that various modifications may be adopted without departing from the spirit of the invention or scope of the following claims.

1. In combination with a ladder having laterally spaced legs having a selected length and supporting rungs spaced longitudinally from one another and each connected to said spaced legs along the length of said legs;
a) a pair of container holders removably mounted to said ladder in laterally aligned opposing relationship to one another along the length of said legs and beyond the width of said legs; and
b) means to removably fix said container holders in a selected position to said ladder along the length of said legs.

2. The combination defined in claim 1 wherein said container holders have an open top, a bottom support and a plurality of spaced side supports defining an open basket configuration.

3. The combination defined in claim 1 wherein each of said container holders includes an outwardly extending arm removably mounted through one of said legs of said ladder toward the other leg in a releasably fixed position.

4. The combination defined in claim 3 wherein said arms extend toward one another and are telescopingly mated to one another between the legs of said ladder.

5. The combination defined in claim 1 wherein said container holders are in the form of an open top enclosed by sidewalls and a bottom wall.

6. The combination defined in claim 1 wherein said ladder is a conventional step ladder and said rungs comprising steps having a generally horizontal planar surface; and said means to removably fix said containers to said ladder include an element having a pair of generally C-shaped laterally spaced openings at a forward end and a pair of laterally spaced openings formed near or at an opposing end a selected distance from said C-shaped openings to extend beyond the legs of said ladder; at least one of said container holders further including an outwardly extending arm configured to be received by said openings disposed in opposing relationship to said generally C-shaped openings to position said container holders in a laterally spaced, aligned opposing position beyond the lateral extent of said legs to releasably fix said container holders in a stable, supported position to said step ladder.
